(19) United States
(12) Patent Application Publication
(10) Pub. No.: US 2005/0207272 A1
(43) Pub. Date: Sep. 22, 2005

(54) Mud tank with pressurized compartment

(75) Inventors: Michael R. Morgenthaler, Houston, TX (US); Federico Alberto Mezzatesta, Houston, TX (US)

Correspondence Address: CONLEY ROSE, P.C., P. O. BOX 3267, HOUSTON, TX, 77253-3267, US

(73) Assignee: National-Oilwell, L.P., Houston, TX (US)

(21) Appl. No.: 10/803,324

(22) Filed: Mar. 18, 2004

(51) Int. Cl. B01F 5/12

(52) U.S. Cl. 366/262

(57) ABSTRACT

An agitator for agitating drilling fluid or other slurries or mixtures in a tank includes a pressurized and fluid-free compartment within the tank. The motor driving the agitator is housed in the fluid-free compartment. Control apparatus senses fluid levels and, in conjunction with a compressed gas source, maintains the compartment fluid-free. Additionally, when the fluid level in the enclosure drops to a predetermined minimum, the speed of the agitator may be slowed.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

1. Field of the Invention

This invention relates to the field of liquid and slurry agitation, and more specifically to the agitation of drilling fluid stored in tanks and as employed in the drilling industry.

2. Background Information

A key component or system that is employed in the drilling of oil and gas wells is the mud system, which circulates drilling fluid (mud) through the wellbore. The circulation system is also used to maintain the density of the drilling fluid by removing drilled cuttings from the fluid, and adding other solids to the fluid as may be desired. The density of the drilling fluid is critical to hole cleaning, rate of penetration, and pressure control in the well. Hole cleaning and rate of penetration are important factors in the efficiency of the drilling process, while pressure control is critical to drilling a well safely.

In general operation, drilling fluid is pumped by high-pressure pumps through the drill string and into the wellbore. The fluid exits the drill string at the bit and returns to the surface through the annulus between the drill string and the wellbore, carrying cuttings from the hole to the surface. The hydrostatic pressure from the column of drilling fluid prevents fluids from the surrounding earthen formation from entering the wellbore and potentially causing well blow out.

At the surface, the drilling fluid is then processed, in order to maintain the desired density, before it is pumped back through the drill string into the hole. The drilling fluid, including a reserve volume, is typically stored in mud tanks at the surface before being recirculated through the well.

The mud tanks are typically fabricated of steel and have a top or ceiling that serves as a deck upon which equipment is placed and personnel can walk and perform various duties. The mud tanks may have agitators or stirrers provided to keep the fluid circulating within the tank in order to minimize settling of the solids and other additives that are used to control the density and viscosity of the liquid slurry.

The conventional agitator has a motor that drives a shaft and an impeller. The motor is normally placed on the top surface of the deck with the shaft and impeller extending down into the drilling mud. This conventional placement of the agitator motor, bearing and associated components on the deck of mud tanks presents operational difficulties and drawbacks. For example, space on the deck is limited during drilling operations. By positioning the agitator motor and related components on the top surface of the deck, the available space for other equipment and operating space for rig personnel is reduced. Deck-mounted equipment also presents trip hazards to personnel working or walking on the deck.

Therefore, it is highly advantageous to increase the available space on the decking that serves as the ceiling or top of the mud tank. Submerged agitators have been used in the past to increase the available space on the top of the mud tank. The submerged agitators are submerged in the drilling mud and are typically secured to a side wall of the mud tank. Drawbacks of using submerged agitators include difficulties in removal of the agitator from the mud tank, as when servicing is required. Further drawbacks include the typical high initial expense of the submerged agitator. In addition, when the submerged agitator is secured to a side wall of the mud tank, the submerged agitator may not properly stir the drilling mud because of the horizontal motion of its impellers in relation to the mud tank. Moreover, the impeller speed of the submerged agitator is generally not adjusted depending on the mud level in the tank, which can result in a reduced life for the agitator motor if it must consistently operate at a high speed even at low mud levels, for example.

Consequently, there is a need for an agitator that provides greater space on the top or deck of the mud tank. Further, there is a need for an agitator mounted below the deck of the mud tank that is more easily removed from the mud tank for service. In addition, there is a need for a more effective way of stirring the drilling mud with an agitator mounted below the deck of the mud tank. Moreover, there are additional needs for extending the life of the agitator motor.

### BRIEF SUMMARY OF SOME OF THE PREFERRED EMBODIMENTS

Preferred embodiments described herein include agitator apparatus for agitating a fluid or slurry contained within a tank or other enclosure. A vessel or chamber is disposed in the tank and includes a fluid-free compartment housing a motor. A shaft is connected to the motor and extends from the fluid-free compartment into the fluid. Blades and/or impellers are attached to the shaft at a position outside of the vessel for agitating the fluid in the tank.

The fluid-free compartment may be pressurized to maintain the fluid level in the vessel below the motor. This enables a non-submersible and thus, less costly, motor to be employed. A hatch or other accessway may be provided in the enclosure to allow access into the fluid-free compartment for servicing the agitator motor and related components.

In certain embodiments, the apparatus includes a controller and a level detector in the vessel for sensing the fluid level and sending a signal to the controller when the fluid level in the vessel rises to a predetermined level. In this arrangement, the controller is electrically coupled to a compressed gas source and causes the source of compressed gas to communicate gas into the fluid-free compartment to maintain the fluid level below the predetermined level and thus below the motor.

In certain embodiments, the apparatus further includes a pressure relief valve coupled electrically to the controller and adapted to open to cause gas to escape from the fluid-free compartment upon receipt of a control signal from the controller. The apparatus may include a second level detector in the vessel adapted to sense when the fluid in the vessel reaches a second predetermined level that is below the first predetermined level. The second or “low” level detector is also electrically coupled to the controller and, in this preferred embodiment, the controller actuates the pressure relief valve when the second level detector has detected that the fluid level in the vessel has reached the second predetermined or “low” level. Additionally, in certain embodiments of the invention, when the fluid level in the enclosure reaches the second predetermined or “low” level, as sensed by the second level detector, the second level detector signals the controller and the controller slows the speed of the motor and thus the speed of agitation in the enclosure or tank.

In certain preferred embodiments, the vessel is sealed and is pressurized to a pressure exceeding the ambient air pressure. The pressurized gas in the vessel maintains the fluid level in the vessel below the first predetermined level, and thus below the motor, and thereby maintains the compartment in a fluid-free and dry condition.

The agitator motor may be an electric or hydraulic motor. It is believed that slowing the speed of the motor and agitator shaft and blades upon sensing of a low level condition has the advantage of increasing the life of the agitator as compared to similar agitators which continue to operate at relatively high speeds even when the fluid level in the enclosure has dropped significantly.

Further, as understood from the following more detailed discussion, positioning the agitator motor in the fluid-free compartment inside the enclosure, as opposed to conventional apparatus where the motor is placed on top of the enclosure, provides a valuable savings in working space for personnel, reduces trip hazards for personnel, and provides or frees space for other required equipment.

Thus the disclosed devices and methods are believed to comprise a combination of features and advantages which enable them to overcome certain drawbacks inherent the prior art devices and methods. The various characteristics described above, as well as other features, will be readily apparent to those skilled in the art upon reading the following detailed description, and by referring to the accompanying drawings.

### BRIEF DESCRIPTION OF THE DRAWINGS

For a detailed description of the preferred embodiments of the invention, reference will now be made to the accompanying drawings in which:

FIG. 1 shows, in schematic form, a cross-sectional view of one embodiment of a pressurized compartment housing an agitator motor within a mud tank; and

FIG. 2 shows an enlarged view of the compartment and agitator apparatus of FIG. 1.

### DETAILED DESCRIPTION OF THE PREFERRED EMBODIMENTS

The following discussion is directed to various specific embodiments of the invention. Unless otherwise specified, the embodiments disclosed should not be interpreted as limiting, or otherwise used to limit, the scope of the disclosure or claims. In addition, one skilled in the art will understand that the following description has broad application. The discussion of any specific embodiment is meant only to be exemplary of that embodiment and is not intended to suggest that the scope of the disclosure or claims is limited to that particular embodiment. In this disclosure, numerous specific details may be set forth to provide a sufficient understanding of the embodiment. However, those skilled in the art will appreciate that the invention as claimed may be practiced without such specific details. In other instances, well-known elements may have been illustrated in schematic or block diagram form in order not to obscure the disclosure in unnecessary detail. Additionally, some details may have been omitted where such details were not considered necessary to obtain a complete understanding of the embodiment, and are considered to be within the understanding of persons of ordinary skill in the relevant art.

As used herein, the terms “couple” or “couples” or “coupled” are intended to mean either a direct or an indirect connection or link between devices that communicate with one another. Thus, for example, if a first device “couples” to a second device, that connection may be through a direct connection, or through an indirect connection via intermediate devices and connections. Further, the terms “electrically coupled” or “coupled electrically” mean that the components are coupled for communications either by wire conductors, fiber optic means, or may be connected by radio signals, or other communication means.

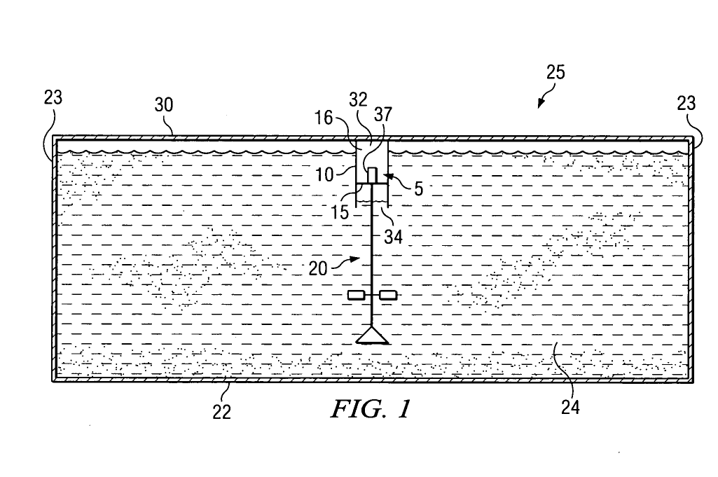

Referring to FIG. 1, there is shown a schematic representation of a fluid-containing tank which, in this embodiment, constitutes mud tank 25 containing drilling mud 24. Mud tank 25 includes vessel 10 housing agitator apparatus 5. Vessel 10 includes fluid-free compartment 16. Agitator apparatus 5 includes agitator motor 37, supported on platform 15 within compartment 16, and agitator 20 extending downwardly from compartment 16 to agitate drilling mud 24. As explained in more detail below, agitator 20 extends downward from compartment 16 and into the body of drilling mud 24 contained in mud tank 25. Tank 25 includes bottom 22, sides 23 and top 30. As conventional, bottom 22 and four sides 23 (two shown in FIG. 1) are welded together to form a fluid-tight enclosure or tank. Top 30 may likewise be welded or otherwise suitably attached to sides 23.

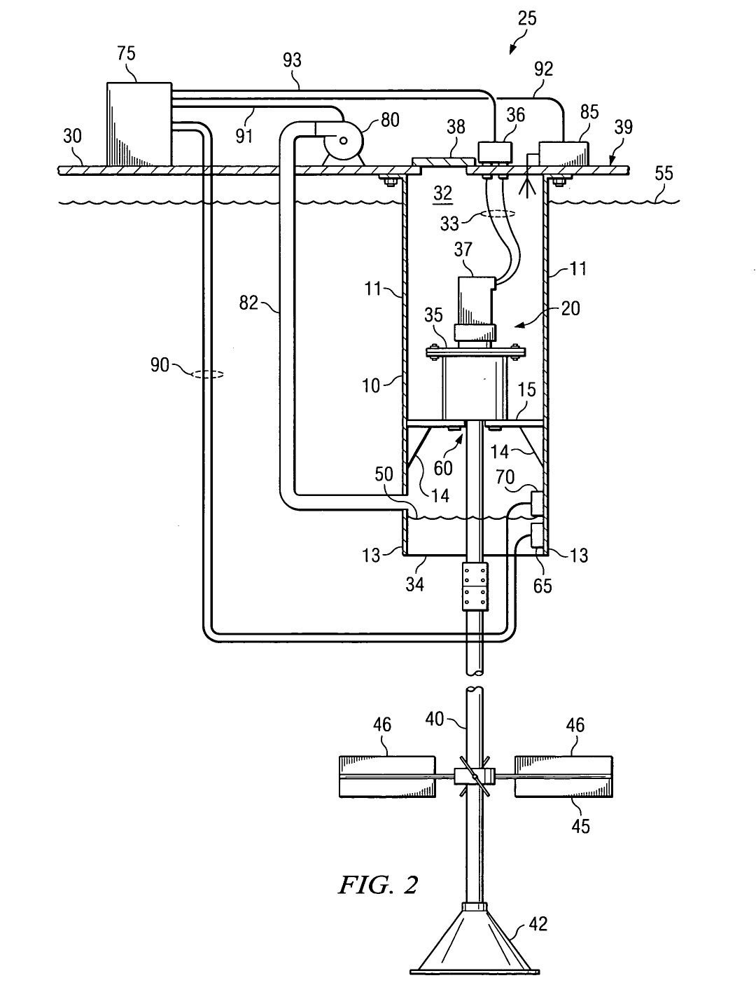

Referring now to FIG. 2, attached to top 30 and extending downwardly into the drilling mud 24 is vessel 10. Vessel 10 includes side walls 11 and a support or platform 15 attached to and extending between walls 11. Vessel 10 is bolted or otherwise attached to tank top 30. In certain embodiments, vessel 10 and platform 15 may be supported by a frame (not shown) attached to tank top 30 so as to simplify assembly and service of the system.

A gasket or other suitable seal (not shown) is disposed between vessel 10 and top 30 to allow compartment 16 to be pressurized. Vessel 10 includes lowermost end 13 that includes opening 34 allowing the drilling mud in tank 25 to communicate into vessel 10. As explained in more detail below, the level of drilling mud within vessel 10 is controlled, such that the level remains beneath platform 15. Vessel 10 may be cylindrical, rectangular, or any other suitable shape. Platform 15 may be sized and shaped to match the cross-sectional shape of vessel 10, or may simply comprise, for example, transverse or cantilevered beams or other members that extend across chamber 10. In this embodiment, platform 15 is attached to sides 11 and also attached to braces 14 that extend from walls 11. Platform 15 further includes an aperture 60 for receiving agitator shaft 40.

Referring still to FIG. 2, agitator apparatus 5 generally includes agitator motor 37 and agitator 20. Agitator 20 includes impeller 45 and extends between bearing 35 in vessel 10 and bearing support 42 disposed on the bottom 22 of the mud tank 25.

Motor 37 and bearing 35 are mounted within fluid-free compartment 16 and supported by platform 15. In this embodiment, it is preferred that motor 37 be a hydraulic motor, although other types of driving apparatus may be employed, such as an electric motor. Bearing 35 helps support the weight of shaft 40 and impeller 45. Shaft 40 extends from bearing 35 through platform aperture 60 to drive and thereby rotate impeller 45. Motor 27 and bearing 35 are mechanically coupled in a conventional manner. Motor 37 may drive shaft 40 through a gearbox (not shown for clarity). Impeller 45 includes a plurality of blades or paddles 46 (four shown in this embodiment).

Top 30 of tank 25 includes an accessway into chamber 10 which, in this embodiment, comprises hatch 38 that is removably attached to tank top 30. Hatch 38 and the accessway that it covers is sized so as to allow access into compartment 16 to allow removal of motor 37 and bearing 35 as repair or maintenance so requires. A gasket (now shown) or another seal is disposed between hatch 38 and tank top 30 to enable compartment 16 to be pressurized and sealed. The weight of the drilling mud 24 seals compartment 16 at opening 34.

The upper surface of tank top 30 forms deck 39 that is used as a walkway by operating personnel and as a surface for supporting various equipment utilized in the operation and control of agitator apparatus 5. More specifically, in this particular embodiment, supported atop deck 39 is controller 75, compressor 80 and pressure-relief valve 85. Controller 75 preferably is a computer or programmable controller. Compressor 80 is a conventional gas compressor that is adapted to pressurize compartment 16 in vessel 10 by means of the interconnecting conduit 82. As shown in FIG. 2, the lowermost end of conduit 82 extends to and opens into compartment 16 above opening 34.

Referring still to FIG. 2, mounted within vessel 10 are minimum and maximum level detectors 65, 70, respectively. Level detectors 65 and 70 are electrically coupled to controller 75 via conductors 90, it being understood that each conductor 90 shown in FIG. 2 may represent a pair of wires, a control cable, multiple conductors or other means for conducting electrical signals. Controller 75 is also electrically coupled to compressor 80 via conductor 91 so as to turn on and off the compressor when required, as described below. Conductor 92 electrically couples pressure-relief valve 85 with controller 75 such that controller 75 may cause pressure-relief valve 85 to open and release pressure within compartment 16, or close so as to maintain a desired pressure within the compartment 16.

A hydraulic control module 36 for actuating hydraulic motor 37 is electrically coupled to controller 75 via conductor 93 such that, upon receipt of the appropriate electrical signal from controller 75, the hydraulic control module 36 will actuate to cause operation of hydraulic motor 37 by communicating pressurized fluid to motor 37 via hydraulic lines 33. Conductors 91, 92, 93 shown in FIG. 2 may be multiple conductor cables, wire pairs, or other suitable electrical conductors.

In operation, controller 75 actuates compressor 80 to pressurize the interior volume 32 of compartment 16 and to maintain the drilling mud level 50 at a level that is beneath platform 15. Due to this pressurization, mud level 50 is thus well below the level 55 to which the drilling mud extends elsewhere in mud tank 25. Essentially then, compartment 16 is dry or fluid-free such that a conventional motor (as opposed to a more expensive submersible motor) may be employed in vessel 10 to actuate the agitator 20 within the tank 25. Level detectors 65, 70 in conjunction with controller 75, operate to control mud level 50 within chamber 10 within predetermined limits. Should the level 50 within chamber 10 reach maximum level detector 70, the detector transmits a control signal to controller 75 via conductors 90. Upon receipt of such signal, controller 75 actuates compressor 80 to increase the gas pressure within chamber 10 to drive the mud level 50 down below level detector 70. Similarly, should the level 50 within chamber 10 reach a predetermined minimum level, a control signal from level detector 65 to controller 75 signals controller 75 to cause pressure-relief valve 85 to open and thereby release pressure from within compartment 16 to allow the fluid level 50 to rise. Valve 85 can comprise any known valve suitable for releasing pressure. In alternative embodiments, more than one valve 85 can be used to release pressure from compartment 16.

The present invention is not limited to securing vessel 10 to tank ceiling 30 but includes alternative embodiments comprising securing vessel 10 to any surface in mud tank 25, such as side walls 23.

In alternative embodiments, more than one compressor 80 may be used to supply gas to compartment 16. The gas can include atmospheric air, stored air, processed air, air that has been purified of flammable or hazardous gases and vapors, and the like. In addition, the present invention is not limited to supplying air to vessel 10 but may include supplying nitrogen or other gas suitable for use in drilling mud operations. Additionally, other sources for supplying compressed gas can be employed in place of the compressor 80.

With compartment 16 sealed, pressure within the compartment prevents the drilling mud 24 from rising up and enveloping motor 37. As shown on FIG. 2, the drilling mud level 50 in compartment 16 is lower than or beneath the drilling mud level 55 in mud tank 25.

The rotational speed of agitator 20 may be adjusted depending on the level 55 of drilling mud in mud tank 25. More specifically, when the drilling mud level 50 drops below minimum level detector 65 in vessel 10, compressor 80 is shut off as previously described. Controller 75 will record that compressor 80 is off. With compressor 80 off, if low level detector 65 again detects a low level condition within vessel 10, then the level 55 within tank 25 has dropped to the level of low level detector 65. Detector 65 again communicates or signals the low level condition to controller 75 which, in this instance, communicates with hydraulic control module 36 to lower the rotational speed of agitator 20. This will have the potential to extend life of the agitator 20. When drilling mud is added to tank 25 such that the mud level 55 in mud tank 25 again increases above minimum level detector 65, controller 75 is signaled by detector 65 of the new, higher level and controller will then signal hydraulic control module 36 to increase the rotational speed of agitator 20 to a desired rotational speed.

The communications between control box 75 and level detectors 65 and 70, compressor 80, hydraulic control module 36 and valve 85 can be sent by hardwire 90, 91, 92, 93 as previously described. Such communications however are not limited to hardwire, but instead may be sent by any other suitable means including fiber optic cables, radio signals and the like.

It will be understood that the present invention is not limited to an arrangement including both minimum level detector 65 and maximum level detector 70. In alternative embodiments, a single detector may be used to measure the drilling mud level in compartment 16 and to signal controller 75 when the level reaches a predetermined maximum level that is below the level of motor 27. In still other alternative embodiments, three or more level detectors can be used to monitor and control the drilling mud levels 30 in chamber 10.

Even though the preferred embodiments described above describe mounting agitator 20 in a sealed and fluid-free chamber 16 below the drilling mud level 55 in a mud tank, the present invention is expressly not limited to use with mud tanks and will be useful in various other applications. For instance, the present invention would prove useful in waste treatment operations by mounting an agitator motor 37 in a sealed compartment 16 below the waste level and stirring the waste with agitator 20 that extends from the fluid-free compartment into the waste slurry. In addition, the present invention can be used in any application in which an agitator may be used to stir a liquid in a tank, pit, or the like.

Although certain preferred embodiments of the present invention and some of their advantages have been described in detail, it should be understood that various changes, substitutions and alterations can be made herein without departing from the spirit and scope of the invention as defined by the appended claims.

1. An apparatus comprising:
a tank containing a fluid;
a vessel within said tank, said vessel including a compartment that is free of said fluid;
a motor housed in said fluid-free compartment; and
a shaft connected to said motor and extending from said fluid-free compartment and into said fluid.

2. The apparatus of claim 1 wherein said tank has an exterior that is in contact with air at an ambient air pressure, and wherein said fluid-free compartment is pressurized to a pressure exceeding the ambient air pressure.

3. The apparatus of claim 2 further comprising a source of compressed gas located outside said tank and a conduit extending between said compressed gas source and said fluid-free compartment adapted to communicate gas between said source of compressed gas and said fluid-free compartment.

4. The apparatus of claim 3 further comprising: a controller, a level detector in said vessel adapted to sense fluid level and to send an electrical signal to said controller when fluid in said vessel rises to a predetermined level; said controller electrically coupled to said source of compressed gas and adapted to cause said source of compressed gas to communicate gas via said conduit to said fluid-free compartment upon receipt of said signal from said level detector.

5. The apparatus of claim 4 further comprising a pressure-relief valve electrically coupled to said controller and adapted to open to cause gas to escape said fluid-free compartment upon receipt of a control signal from said controller.

6. An apparatus for agitating a fluid comprising:
an enclosure containing fluid extending to a first level in said enclosure, said enclosure including a top;
a vessel attached to said enclosure top and extending from said top into said fluid;
a fluid-free compartment in said vessel, said fluid extending in said vessel to a second fluid level that is below said first fluid level;
a motor disposed in said fluid-free compartment at a position between said first and second fluid levels; and
a shaft connected to said motor and extending out of said fluid-free compartment and into said fluid.

7. The apparatus of claim 6 further comprising a conduit extending between said fluid-free compartment and a location outside said enclosure, and a means for supplying gas through said conduit into said fluid-free compartment.

8. The apparatus of claim 7 wherein said enclosure has an exterior that is in contact with air at an ambient air pressure, and wherein said fluid-free compartment is pressurized to a pressure exceeding the ambient air pressure.

9. The apparatus of claim 8 wherein said means for supplying gas includes a gas compressor located on said top of said enclosure.

10. The apparatus of claim 6 further comprising an agitator, said agitator including an impeller in said enclosure and mounted on said shaft at a location outside of said vessel.

11. The apparatus of claim 7 further comprising: a controller coupled electrically to said means for supplying gas; a first level detector in said vessel and coupled electrically to said controller, said first level detector indicating to said controller when said second fluid level in said vessel reaches a predetermined maximum level causing said controller to signal said means for supplying gas to supply gas to said fluid-free compartment via said conduit.

12. The apparatus of claim 11 further comprising: a second level detector coupled electrically to said controller for indicating to said controller when said second fluid level reaches a predetermined minimum level; and a pressure relief valve coupled electrically to said controller and adapted to release gas from said vessel upon receipt of a control signal from said controller.

13. The apparatus of claim 12 wherein said motor is a hydraulic motor and said apparatus further comprises a hydraulic control module coupled electrically to said controller and adapted to control the speed of said motor.

14. An apparatus comprising:
an enclosure containing fluid that extends to a first fluid level within said enclosure;
a top on said enclosure and a vessel attached to said top and extending into said fluid, said vessel including a lower end having an opening allowing said fluid to extend into said vessel to a second level, said second level being below said first level;
a pressurized compartment within said vessel extending between said second fluid level and said enclosure top;
a motor in said pressurized compartment;
a shaft connected to said motor and extending from said vessel into said fluid;
an agitator connected to said shaft and disposed in said fluid beneath said second fluid level;
a level detector in said vessel electrically coupled to a controller that is disposed outside of said enclosure;
a source of compressed gas located outside said enclosure and coupled electrically to said controller;
a conduit extending between said compressed gas source and said pressurized compartment;
wherein said level detector, controller and compressed gas source are electrically coupled so that a signal generated by said level detector and received by said controller causes said controller to signal said compressed gas source to supply compressed gas into said compartment to maintain said second fluid level below said motor.

15. The apparatus of claim 14 further including a platform disposed within said vessel above said second fluid level supporting said motor.

16. The apparatus of claim 15 wherein said level detector is positioned at a location below said platform.

17. The apparatus of claim 16 further comprising an accessway formed in said top of said enclosure into said pressurized compartment of said vessel, said accessway including a removable cover sealed to said enclosure top.

18. The apparatus of claim 14 further including a pressure relief valve electrically coupled to said controller and adapted to lower the pressure within said pressurized compartment upon receipt of a signal from said controller.

19. The apparatus of claim 14 further comprising a means to reduce the rotational speed of said shaft when said first fluid level reaches a predetermined minimum level.

20. An apparatus for retaining a fluid level in a vessel below a pre-determined level, the apparatus comprising:
a vessel having an opening at a first end thereof;
fluid surrounding said vessel and entering into said opening to a first fluid level;
a pressurized region in said vessel above said first fluid level;
control apparatus to keep said fluid in said vessel below the pre-determined level, said control apparatus comprising:
a controller;
a compressor adapted to supply pressurized gas to said pressurized region upon receipt of a control signal from said controller;
a first level detector in said vessel adapted to send a signal to said controller when said fluid level in said vessel rises to said first pre-determined level;
said compressor and said first level detector being electrically coupled to said controller.

21. The apparatus of claim 20 further comprising a second level detector in said vessel positioned below said first level detector and adapted to send a signal to said controller when said fluid level in said vessel drops to a second predetermined level that is less than said first predetermined level.

22. The apparatus of claim 21 further including means for causing said compressor to stop supplying pressurized gas to said pressurized region when said fluid level reaches said second fluid level.

23. The apparatus of claim 21 further including a pressure relief valve electrically coupled to said controller and adapted to release gas from said pressurized region upon receipt of a signal from said controller.

24. The apparatus of claim 21 further comprising a motor disposed in said pressurized region connected to a rotatable shaft extending from said pressurized region to outside of said vessel; and a plurality of mixing blades connected to said shaft at a location outside of said vessel.

25. The apparatus of claim 24 wherein said controller is coupled electrically to said motor and controls the rotational speed imparted to said shaft by said motor.

26. The apparatus of claim 25, wherein said second level detector in said vessel is adapted to send a signal to said controller when said fluid level in said vessel drops to a second predetermined level that is less than said first predetermined level, and wherein said controller, upon receipt of said signal from said second level detector, causes said motor to lower the rotational speed of said shaft.

27. A method of agitating a fluid in a tank with a rotatable agitator, the method comprising:
monitoring the level of the fluid in the tank;
sensing when the fluid level in the tank has dropped below a predetermined level;
signaling a controller that the fluid level is below the predetermined minimum level; and
slowing the rotation of the agitator.
